(19) United States
(12) Patent Application Publication
(10) Pub. No.: US 2026/0171798 A1
(43) Pub. Date: Jun. 18, 2026

(54) METHOD AND SYSTEM FOR ELIMINATING ABNORMAL ACTIVE LOADS IN REGIONAL ENERGY INTERNET

(71) Applicant: SHANDONG UNIVERSITY, Jinan (CN)

(72) Inventors: Tianguang LU, Jinan (CN); Yixiao LI, Jinan (CN); Wenbo LI, Jinan (CN); Donglei SUN, Jinan (CN); Xueqian HE, Jinan (CN); Qian AI, Jinan (CN); Shumin SUN, Jinan (CN)

(21) Appl. No.: 19/530,499

(22) Filed: Feb. 5, 2026

Related U.S. Application Data
(63) Continuation-in-part of application No. 17/749,994, filed on May 20, 2022.

(30) Foreign Application Priority Data
Sep. 15, 2021 (CN) 2021110790637

(51) Int. Cl. H02J 3/001; H02J 13/12

(52) U.S. Cl. CPC H02J 3/001; H02J 13/12

(57) ABSTRACT

A method and system for eliminating abnormal active loads in a regional energy internet (EI). The method may comprise: acquiring several types of meteorological data values, to calculate coupled meteorological factor indexes, and constructing influence factor matrix; acquiring active load data to construct basic state matrix; constructing augmented data source matrix through basic state matrix data and influence factor matrix data; calculating Pearson correlation coefficients to construct Pearson correlation coefficient matrix; constructing source matrix through Pearson correlation coefficient matrix data and basic state matrix data; performing matrix transformation on source matrix to obtain random matrix; performing spectrum analysis on characteristic values of random matrix to obtain probability density distribution; identifying abnormalities in active load data by comparing probability density distribution with historical probability density distribution in normal state; and load balancer executes corresponding coordinated control actions according to parameters of abnormalities, to eliminate abnormal active loads in the regional EI.

### CROSS-REFERENCE TO RELATED APPLICATIONS

The present application is a continuation-in-part of U.S. application Ser. No. 17/749,994, filed May 20, 2022, the entire contents of which are incorporated herein by reference.

### TECHNICAL FIELD

The present application relates to the technical field of power active load data analysis and abnormal active load elimination, and particularly relates to a method and system for eliminating abnormal active loads in a regional energy internet (EI).

### BACKGROUND

The statements in this section merely provide background related to the present application and do not necessarily constitute the prior art.

At present, non-traditional main units have been gradually industrialized and applied to power grids. The power system is regarded as a typical big data system, which continuously generates massive, heterogeneous, real-time, and real data. The state of the power system is susceptible to a variety of external factors, and the consumption behavior of power users is complicated and changeable. Therefore, taking the behavior of the power users into full consideration and stimulating the users' subjective initiative to realize the transition from passive load to active load is of great significance to the construction of modern power grids.

The inventors found that currently the load forecasting and load abnormality data identification of the power grid mostly rely on traditional physical modeling methods, which cannot cope with the increasing complexity of power grids and cannot meet the requirements of real-time analysis and accuracy. Singular scattered meteorological factors (such as wind speed, wind direction, sunshine intensity and time, rainfall, atmospheric pressure and other meteorological factors which are independent) alone cannot reveal the correspondence with the power active load, leading to a low accuracy in recognizing abnormal data of the power active load. During the identification of the abnormal data of the power active load, if data measured by a power grid measurement terminal is directly introduced and transformed into a random matrix, abnormality of single or single-batch data of the power grid is prone to the occurrence of state identification omission or mis-identification.

### SUMMARY

To overcomes the defects in the prior art, the present application provides a method and system for eliminating abnormal active loads in a regional EI, which may improve an identification accuracy of abnormal data in active load data, and may eliminate abnormal active load in real times by adopting accurate and reasonable dispatching control response strategies.

To achieve the foregoing objective, the present application uses the following technical solutions.

In the first aspect, the present application provides a method for eliminating abnormal active loads in a regional EI.

In one or more examples in the present specification, the method for eliminating the abnormal active loads in the regional EI, comprising the following process:
acquiring data values of several types of meteorological data in real-time from a regional weather station in a region to be analyzed, and acquiring active load data of a regional EI of the region to be analyzed by using an electric data collection system (EDCS) in the regional EI;
calculating a plurality of coupled meteorological factor indexes according to the acquired data values;
constructing an influence factor matrix based on data of the plurality of the coupled meteorological indexes;
constructing a basic state matrix based on the acquired active load data;
constructing an augmented data source matrix by splicing the basic state matrix and the influence factor matrix;
calculating Pearson correlation coefficients by using the augmented data source matrix;
then, constructing a Pearson correlation coefficient matrix by using the calculated Pearson correlation coefficients; wherein, the Pearson correlation coefficients are configured to reflect linear correlation degrees between the plurality of the coupling meteorological factor indexes and the active load data;
constructing a source matrix by splicing the Pearson correlation coefficient matrix and the basic state matrix;
performing matrix transformation on the source matrix to obtain a random matrix;
performing spectrum analysis on characteristic values of the random matrix to obtain a probability density distribution;
identifying whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a load balancer (LB) deployed within the regional EI; the LB is controlled to execute corresponding coordinated control actions according to a preset response strategy mapping table, specially comprises:

when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation.

In one or more examples of the present application, constructing the augmented data source matrix by splicing the basic state matrix and the influence factor matrix, comprises:
taking time points as number of columns, and taking the active load data represent number of rows, to construct the basic state matrix;
taking the time points as the number of columns, and taking the data of the plurality of the coupled meteorological indexes represent the number of rows, to construct the influence factor matrix; and
top-bottom splicing the basic state matrix and the influence factor matrix, to obtain the augmented data source matrix;
wherein, the basic state matrix is on an upper portion of the augmented data source matrix, and the influence factor matrix is on a lower portion of the augmented data source matrix.

In one or more examples of the present application, calculating the Pearson correlation coefficients by using the augmented data source matrix, comprises:
selecting a sub-matrix from the augmented data source matrix by moving a window, calculating a Pearson correlation coefficient by using the active load data in a certain row of the sub-matrix and the data of the plurality of the coupled meteorological indexes in a row of the sub-matrix corresponding to the certain row; and
obtaining the Pearson correlation coefficients between the active load data and the data of the plurality of the coupled meteorological indexes in the sub-matrix after multiple calculations.

In one or more examples of the present application, performing the matrix transformation on the source matrix to obtain the random matrix, comprises the following process:
acquiring the source matrix at a certain sampling moment;
transforming the source matrix into a standard non-Hermitian matrix;
according to the obtained standard non-Hermitian matrix, calculating a plurality of singular value equivalent matrices;
multiplying the plurality of the singular value equivalent matrices to obtain a matrix to be analyzed;
converting the matrix to be analyzed into a standard matrix with a mean value of 1 and a variance of 0; and
calculating a covariance matrix of the standard matrix, and defining the covariance matrix as the random matrix obtained after the matrix transformation.

In one or more examples of the present application, performing the spectrum analysis on the characteristic values of the random matrix to obtain the probability density distribution, comprises:
calculating the characteristic values of the random matrix obtained after the matrix transformation;
performing the spectrum analysis according to the characteristic values;
obtaining the probability density distribution of the Pearson correlation coefficients according to results of the spectrum analysis; and
obtaining correspondence linear correlation degrees between the plurality of the coupled meteorological factor indexes and the active load data according to the probability density distribution of the Pearson correlation coefficients.

In one or more examples of the present application, the plurality of the coupled meteorological factor indexes, at least comprises:

a heat index (HI):

$$HI = {c}_{1} + {c}_{2} T + {c}_{3} R + {c}_{4} T R + {c}_{5} {T}^{2} + {c}_{6} {R}^{2} + {c}_{7} {T}^{2} R + {c}_{8} T {R}^{2} + {c}_{9} {T}^{2} {R}^{2} ;$$

wherein, c₁, c₂, c₃, c₄, c₅, c₆, c₇, c₈ and c₉ are constant coefficients, T is temperature and R is relative humidity.

In some examples, the plurality of the coupled meteorological factor indexes, at least comprises:

an effective temperature Tₑ:

$${T}_{e} = 37 - \frac{( 37 - {T}_{a} )}{[ 0.68 - 0.14 {R}_{h} + \frac{1}{1.76} + 1.4 {V}^{0.75} ) ]} - 0.29 {T}_{a} ( 1 - {R}_{h} ) ;$$

wherein, Tₐ is an air temperature, Rₕ is the relative humidity, and V is a wind speed.

In some examples, the plurality of the coupled meteorological factor indexes, at least comprises:
a human body comfort index k:

$$k = 1.8 {T}_{a} - 0.55 ( 1.8 {T}_{a} - 26 ) ( 1 - {R}_{h} ) - 3.2 \sqrt{V} + 3.2 ;$$

wherein, Tₐ is an air temperature, Rₕ is the relative humidity, and V is a wind speed.

In one or more examples of the present application, the LB may further upload received information parameters of the abnormalities and corresponding response strategies to a power grid dispatching center to participate in auxiliary services such as frequency modulation and peak shaving of EI system.

In the second aspect, the present application provides a system for eliminating abnormal active loads in a regional EI.

In one or more examples in the present specification, the system for eliminating the abnormal active loads in the regional EI, comprising:
a data acquiring module, configured to acquire data values of several types of meteorological data in real-time from a regional weather station in a region to be analyzed, and acquire active load data of a regional EI of the region to be analyzed by using an EDCS in the regional EI;
a coupled meteorological factor index acquiring module, configured to calculate a plurality of coupled meteorological factor indexes according to the acquired data values;
an influence factor matrix acquiring module, configured to construct an influence factor matrix based on data of the plurality of the coupled meteorological indexes;
a basic state matrix acquiring module, configured to construct a basic state matrix based on the acquired active load data;
an augmented data source matrix acquiring module, configured to construct an augmented data source matrix by splicing the basic state matrix and the influence factor matrix;
a Pearson correlation coefficient matrix acquiring module, configured to calculate Pearson correlation coefficients by using the augmented data source matrix; and, construct a Pearson correlation coefficient matrix by using the calculated Pearson correlation coefficients;
a source matrix acquiring module, configured to construct a source matrix by splicing the Pearson correlation coefficient matrix and the basic state matrix;
a random matrix acquiring module, configured to perform matrix transformation on the source matrix to obtain a random matrix;
a data abnormality identification module, configured to perform spectrum analysis on characteristic values of the random matrix to obtain a probability density distribution, and identify whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a LB deployed within the regional EI; the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation.

In the third aspect, the present application provides a computer equipment.

In one or more examples in the present specification, the computer equipment comprising: at least one memory for storing computer instructions; and, at least one processor configured to communicate with the at least one memory; wherein the at least one processor, when executing a set of instructions, is configured to perform the method for eliminating abnormal active loads in the regional EI according to examples of the present invention.

In the fourth aspect, the present application provides a non-transitory computer-readable storage medium.

In one or more examples in the present specification, the non-transitory computer-readable storage medium storing computer instructions, and after a computer reads the computer instructions in the storage medium, the computer executes the method for eliminating abnormal active loads in the regional EI according to examples of the present invention.

Compared with the prior art, the beneficial effects of the present application are as follows:

Firstly, the method and system of the present application generate the coupled meteorological factor index according to the collected meteorological data, and calculate the Pearson correlation coefficient of power data collected by a power grid measurement system and the coupled meteorological factor index, and the Pearson correlation coefficient can sensitively reflect whether the change trend between the abnormal active power data and influence factors is the same. Therefore, if there are different active power abnormal data in the state of similar influence factors, the Pearson correlation coefficient will change significantly, and correspondingly the random matrix model has a more distorted characteristic value distribution, providing a better identification effect, and greatly improving the accuracy in recognizing the abnormal data of the active load.

Secondly, the method and system of the present application combine the Pearson correlation coefficient with the random matrix model, and use linear characteristic values and Pearson correlation coefficients as quantitative indexes, to realize an effective combination of visualization and quantification of correlation, providing an important basis for accurate measurement of the load.

Thirdly, compared with other big data processing methods, the method and system of the present application can merge high-dimensional and heterogenous power data to realize fast real-time calculation and analysis of data. The real-time window translation method applied can fully consider the cumulative effect, and a data block selected during window translation contains a large amount of previous data, which can realize the efficient use of data and avoid the problem that the amount of data in the power system continues to increase but the data utilization rate is low.

### BRIEF DESCRIPTION OF THE DRAWINGS

The accompanying drawings constituting a part of the present application are used to provide a further understanding of the present application. The exemplary examples of the present application and descriptions thereof are used to explain the present application, and do not constitute an improper limitation of the present application.

FIG. 1 is a schematic flow chart of a method for eliminating abnormal active loads in a regional EI provided in Example 1 of the present application.

FIG. 2 is a schematic diagram of a correlation analysis framework provided by Example 1 of the present application.

FIG. 3 is a schematic diagram of construction of a random matrix model provided in Example 1 of the present application.

FIG. 4 is a schematic flow chart of matrix transformation provided in Example 1 of the present application.

FIG. 5 is a schematic diagram of a system for eliminating abnormal active loads in a regional EI provided in Example 2 of the present application.

### DETAILED DESCRIPTION

The present application is further described below with reference to the accompanying drawings and examples.

It should be pointed out that the following detailed descriptions are all illustrative and are intended to provide further descriptions of the present application. Unless otherwise specified, all technical and scientific terms used herein have the same meanings as those usually understood by a person of ordinary skill in the art to which the present application belongs.

It should be noted that the terms used herein are merely used for describing specific implementations, and are not intended to limit exemplary implementations of the present application. As used herein, the singular form is intended to include the plural form, unless the context clearly indicates otherwise. In addition, it should further be understood that terms “comprise/comprising” and/or “include/including” used in this specification indicate that there are features, steps, operations, devices, components, and/or combinations thereof.

The examples in the present specification and features in the examples may be mutually combined in case that no conflict occurs.

### Example 1

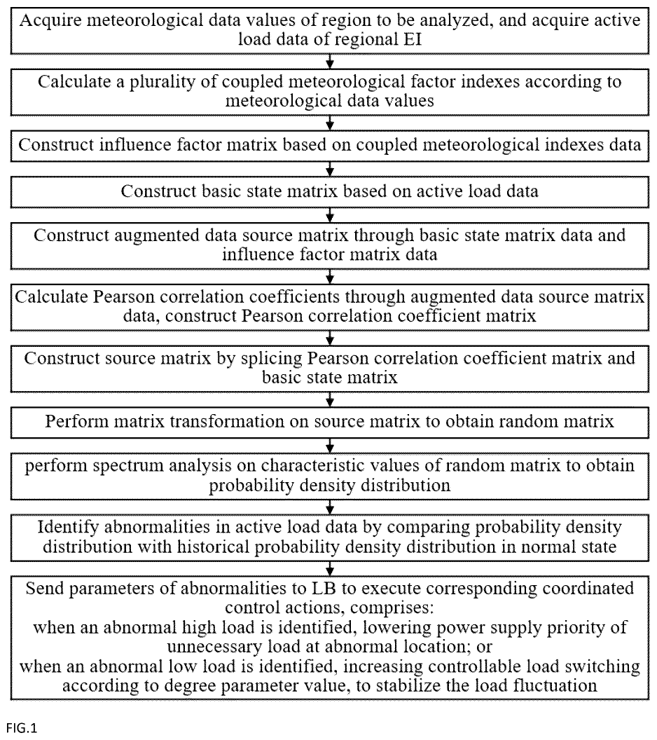

As shown in FIGS. 1 to 4, the Example 1 of the present specification provides a method for eliminating abnormal active loads in a regional EI, comprising the following process:
acquiring data values of several types of meteorological data in real-time from a regional weather station in a region to be analyzed, and acquiring active load data of a regional EI of the region to be analyzed by using an electric data collection system (EDCS) in the regional EI;
calculating a plurality of coupled meteorological factor indexes according to the acquired data values;
constructing an influence factor matrix based on data of the plurality of the coupled meteorological indexes;
constructing a basic state matrix based on the acquired active load data;
constructing an augmented data source matrix by splicing the basic state matrix and the influence factor matrix;
calculating Pearson correlation coefficients by using the augmented data source matrix;
then, constructing a Pearson correlation coefficient matrix by using the calculated Pearson correlation coefficients;
constructing a source matrix by splicing the Pearson correlation coefficient matrix and the basic state matrix;
performing matrix transformation on the source matrix to obtain a random matrix;
performing spectrum analysis on characteristic values of the random matrix to obtain a probability density distribution;
identifying whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a load balancer (LB) deployed within the regional EI;
the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation.

In the present example, the plurality of the coupled meteorological indexes, at least comprises:

### (1) Heat Index (HI)

The HI may comprehensively reflect the coupling effect of two single meteorological factors, temperature and relative humidity, on the perceived temperature of a human body.

The coupling effect of the temperature and humidity is not a simple superposition. When the air temperature is moderate, the change of the relative humidity has less influence on the temperature actually perceived by the human body. When the temperature is high or low, especially in summer and winter, the change of the relative humidity has greater influence on the temperature actually perceived by the human body.

The present application focuses on the high temperature season, and uses the HI to complete the correction on a temperature index by the relative humidity.

A formula for calculating the HI is:

$$HI = {c}_{1} + {c}_{2} T + {c}_{3} R + {c}_{4} TR + {c}_{5} {T}^{2} + {c}_{6} {R}^{2} + {c}_{7} {T}^{2} R + {c}_{8} {TR}^{2} + {c}_{9} {T}^{2} {R}^{2} ; \qquad ( 1 )$$

wherein c₁=−42.38, c₂=2.049, c₃=10.14, c₄=−0.2248, c₅=−6.838*10⁻³, c₆=−5.482*10⁻², c₇=1.228*10⁻³, c₈=8.528*10⁻⁴, c₉=−1.99*10⁻⁶. The application conditions of formula (1) are that the temperature should be greater than 80 degrees Fahrenheit, that is, 27° C., and the relative humidity should be greater than 40%.

### (2) Effective Temperature (ET)

ET refers to a thermal sensation index produced by the human body under different air temperature, humidity and wind speed conditions, and is the manifestation of the coupling effect of three single meteorological factors. In the calculation, the effective temperature is based on the static saturated atmospheric conditions, that is, the temperature at which the human body feels comfortable under the condition that the wind speed is zero and the relative humidity reaches 100% is used to represent different sensible temperatures under the conditions of different wind speeds, different relative humidity and different air temperatures.

A calculating formula of the ET is:

$${T}_{e} = 37 - \frac{( 37 - {T}_{a} )}{[ 0.68 - 0.14 {R}_{h} + \frac{1}{1.76} + 1.4 {V}^{0.75} ) ]} - 0.29 {T}_{a} ( 1 - {R}_{h} ) ; \qquad ( 2 )$$

wherein, Tₑ, Tₐ, Rₕ, and V correspond to the effective temperature, the air temperature, the relative humidity and the wind speed, respectively.

### (3) Human Body Comfort Index (CI)

CI is configured to measure the coupling effect of three single meteorological factors, the temperature, the relative humidity and the wind speed on the human body, and characterize the comfort level of the human body in the atmospheric environment.

A calculating formula of the CI is:

$$k = 1.8 {T}_{a} - 0.55 ( 1.8 {T}_{a} - 26 ) ( 1 - {R}_{h} ) - 3.2 \sqrt{V} + 3.2 . \qquad ( 3 )$$

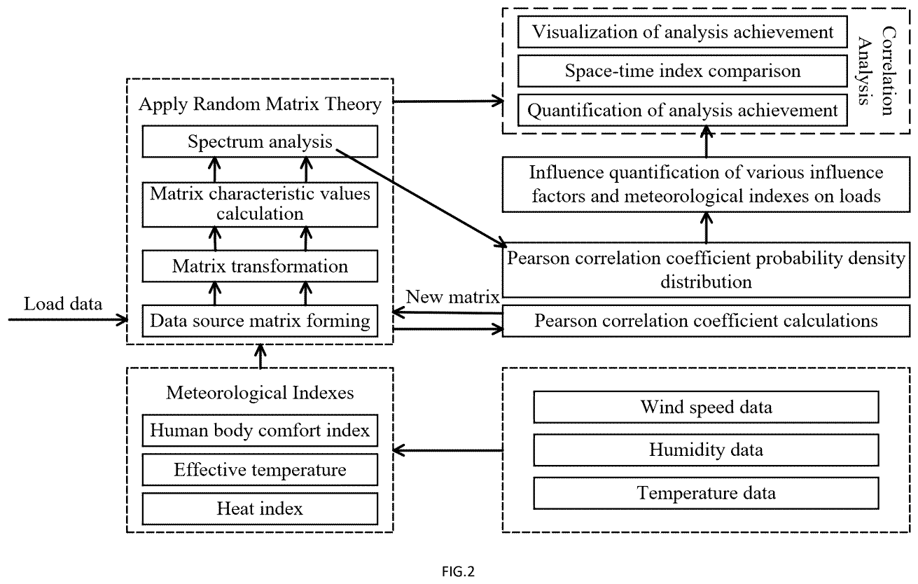

As shown in FIG. 2, in the present example, the random matrix theory and the Pearson correlation coefficient are effectively combined to complete the visualization and quantification of correlation analysis. The random matrix can handle large-scale and various types of data.

In order to analyze the impact of different types of data on the power system, the present example constructs the augmented data source matrix for correlation research.

The augmented data source matrix consists of two parts, namely the basic state matrix and the influence factor matrix. For an n-node system, at a certain moment of tᵢ, each node collects k state variables, and then n nodes obtain N measurement data, wherein N=n*k.

The specific realization process is:

(1) Respectively acquiring power grid data and meteorological data of two cities with different meteorological conditions.

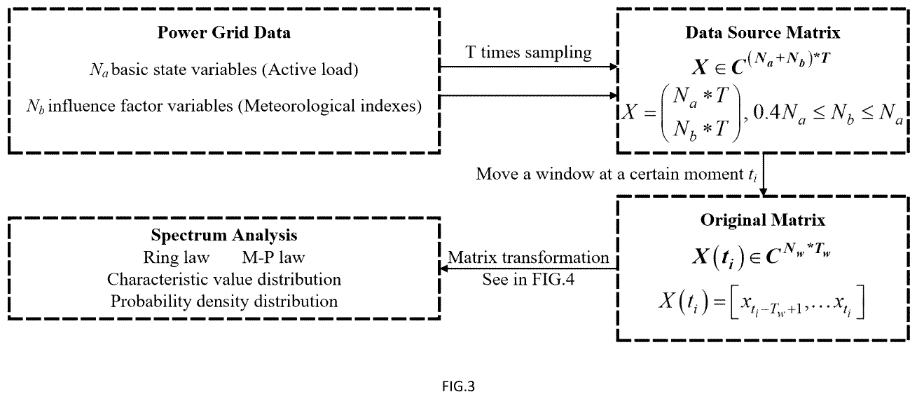

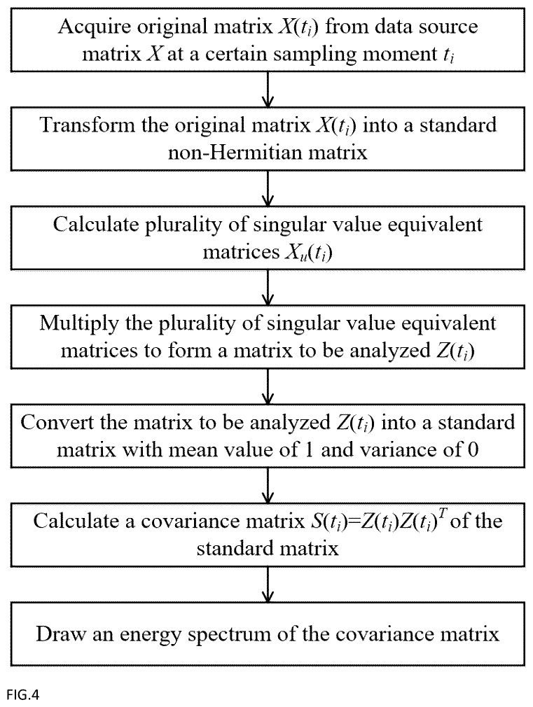

(2) Calculating the plurality of the coupled meteorological indexes according to the values of the plurality of single meteorological factors, using the active load data as data of the basic state matrix data, using the coupled meteorological index data as data of the influence factor matrix, and forming the augmented data source matrix, thereby forming a random matrix model, and as shown in FIG. 3, the matrix transformation flow therein is as shown in FIG. 4.

Specifically, according to the same sampling time node (e.g. 96 nodes, i.e. sampling power grid state data and climate influence factor data once in 15 minutes, the power grid state data comprising data such as voltage, current and active load, and the climate influence factor data comprising temperature, humidity and the like), the coupled meteorological index data (such as the human body comfort index and other data mentioned in the present example) calculated from the power grid state data and basic meteorological factor data such as temperature and humidity is longitudinally listed to obtain the augmented data source matrix, which is then converted into the independent and identically distributed random matrix through data processing shown in FIG. 3, and the advantages that the random matrix accommodates data in flexible and various types and a heterogeneous performance is good are made full use of.

In the present example, the augmented data source matrix comprises two parts: the basic state matrix and the influence factor matrix wherein, the basic state matrix is constructed by the power grid state data obtained from a power grid measurement terminal, and the influence factor matrix is constructed by the coupled factor index data obtained from the calculation of multiple single meteorological factor indexes.

In the present example, during the construction of the basic state matrix, taking time points as the number of columns, let data of a basic state quantity of the power grid represent the number of rows, and preferably, a dimension of 160*160 is used; and
during the construction of the influence factor matrix, also taking the time points as the number of columns and let the coupled meteorological index data represent the number of rows.

In order to effectively reflect the influence of influence factors on the power grid state, when constructing the augmented data source matrix, it should be noted that the ratio c1 between the dimension of influence factor variables and the dimension of basic state variables should be maintained between 0.4 and 1. If the number of collected influence factors is small, collected data should be copied until the limit requirement of the dimension ratio is met.

When the number of the dimension of the random matrix tends to infinity and the row-column ratio c is constant, the empirical spectrum distribution of the characteristic values will converge to the theoretical characteristics according to a random matrix theory. However, in practical applications, rather accurate asymptotic convergence results can also be observed as long as the dimensions of the matrix are relatively moderate, for example, tens to hundreds, which is the theoretical basis for applying the random matrix theory to power system analysis.

Specifically, the effectiveness of the abnormal data identification in the method for eliminating abnormal active loads in the regional EI provided in the present example is expressed by comparing the data density distribution in the normal steady state with the data density distribution in the abnormal state.

Expression of the density distribution is based on an M-P theory and a Ring Law theory, which is two visualization forms of matrix characteristic value distribution, and the two theories can verify each other.

The random matrix theory is specifically that: when the power system state is stable, data satisfy random distribution, and matrix characteristic value distribution is regular and stable.

First, expression of an M-P law: during stabilization, the data density distribution shall be consistent with the theoretical distribution as shown in Equation (6), such as the time to reach a wave peak and a wave peak amplitude, the degree of a curve decline and time shall be consistent.

Expression of the Ring Law theory: in normal distribution, the characteristic values shall be distributed between an inner ring and an outer ring, and the mean spectral radius (the mean value of the matrix characteristic value and the distance from the center of a circle in a complex plane) is generally between 0.7 and 0.8.

If abnormality occurs, for the M-P law: a waveform is distorted, the peak amplitude is decreased greatly, and after the peak appearance time is delayed, and the declining degree of a curve increases. For a Ring Law: the matrix characteristic values are concentrated in the inner ring, and the average spectral radius decreases obviously, generally around 0.4.

Specifically, the M-P law (Marchenko-Pastur law) in FIG. 4 is specifically:
assuming \tilde{X} as a non-Hermitian feature random matrix, each element is an independent and identically distributed random variable, and its elements satisfy:

$$μ ( {x}_{i} ) = 0 , {σ}^{2} ( {x}_{i} ) = constant < ∞ . \qquad ( 4 )$$

The covariance matrix is defined as:

$$S = \frac{1}{N} {XX}^{T} . \qquad ( 5 )$$

After matrix transformation, the energy spectrum distribution of the covariance matrix is:

$${f}_{MP} ( {λ}_{S} ) = \{ \begin{matrix}\frac{1}{2 π {cd λ}_{S}} \sqrt{( b - {λ}_{S} ) ( {λ}_{S} - a )} , & a \leq {λ}_{S} \leq b \\ 0 , & otherwise\end{matrix} \text{} ; \qquad ( 6 )$$

wherein, λₛ is the characteristic value of the matrix, and c is the ratio of the row and column dimensions of the matrix, and should be between 0 and 1, α=d(1−\sqrt{c})², b=d(1+\sqrt{c})².

The Ring Law in FIG. 4 is specifically:
assuming \tilde{X} as a non-Hermitian feature random matrix, each element is an independent and identically distributed random variable, and its elements satisfy:

$$μ ( {x}_{i} ) = 0 , {σ}^{2} ( {x}_{i} ) = 1. \qquad ( 7 )$$

When the dimensions N and T of the matrix tend to infinity, and c=N/T remains the same, empirical spectrum distribution of characteristic values of a singular value equivalent matrix converges to a circular ring, and its probability density function is:

$$f ( {λ}_{\tilde{Z}} ) = \{ \begin{matrix}\frac{1}{π cL} {\vert {λ}_{\tilde{Z}} \vert}^{\frac{2}{L} - 2} , & {( 1 - c )}^{\frac{L}{2}} , \leq \vert {λ}_{\tilde{Z}} \vert \leq 1 \\ 0 , & otherwise\end{matrix} \text{} ; \qquad ( 8 )$$

wherein, λ_{z} is the matrix characteristic value, L is the cumulative number of singular value equivalent matrix, the inner radius of the circular ring is

$${( 1 - c )}^{\frac{L}{2}} ,$$

and the outer radius of the circular ring is 1.

The Pearson correlation coefficient in FIG. 3 is specifically:

The Pearson correlation coefficient is used to reflect statistical indexes of the degree of linear correlation between two variables, focusing more on the relationship between the change trend of one variable and the change trend of another variable, so as to accurately reflect the follow-up performance between two variables, it is represented by the symbol r_{pq}, and the value is limited from −1 to 1. The greater the absolute value of r_{pq}, the stronger the correlation. When r_{pq} is greater than 0, it indicates that the two variables are in positive correlation, and the change trends of the two variables are consistent. A larger r_{pq} indicates a better following characteristic. When r_{pq} is less than 0, the two variables are in negative correlation, and the change trends of the two variables are opposite.

In the present, the Pearson correlation coefficient is used as a statistical index reflecting the degree of linear correlation between the three meteorological factor indexes and the active load data.

A formula for calculating the Pearson Correlation Coefficient is:

$${r}_{pq} = \frac{n {\sum }_{t = 1}^{n} {x}_{p} ( t ) {x}_{q} ( t ) - {\sum }_{t = 1}^{n} {x}_{p} ( t ) {\sum }_{t = 1}^{n} {x}_{q} ( t )}{\sqrt{{( n {\sum }_{t = 1}^{n} {x}_{p}^{2} ( t ) - ( {\sum }_{t = 1}^{n} {x}_{p} ( t ) ) )}^{2} ) {( n {\sum }_{t = 1}^{n} {x}_{q}^{2} ( t ) - ( {\sum }_{t = 1}^{n} {x}_{q} ( t ) ) )}^{2} )}} . \qquad ( 9 )$$

In the present example, in the augmented data source matrix, selecting a sub-matrix by moving a window, calculating a Pearson correlation coefficient between data is calculated by the active load data in a certain row in the sub-matrix and the coupled meteorological factor index data in a corresponding row in sub-matrix, and obtaining the Pearson coefficients between the active load data and the coupled meteorological factor index data in several sub-matrices are obtained after multiple calculations are carried out according to specific sampling times of the sub-matrix.

In the present example, when splicing the basic state matrix and the Pearson correlation coefficient matrix to construct the source matrix, the number of columns of the Pearson correlation coefficient matrix is less than that of the basic state matrix, so it is necessary to copy the Pearson correlation coefficient matrix currently.

At the same time, when selecting the sub-matrix dimension, setting the sub-matrix dimension equal to about one-tenth of the dimension of the source matrix.

The method described in the present example reveals and quantifies the correlation between the coupled meteorological factor and a power consumption behavior (namely, the active load), and when applying a random matrix theory to analyze the correlation between the meteorological factors and the power consumer behavior, the present example achieves an effective combination of actual measurement and simulation, and an effective combination of visualization and quantification.

In terms of visualization: a random augmented data source matrix model is constructed through collected power system data. After matrix transformation, for the standard matrix, real-time processing is achieved by using a window translation method, and a characteristic value distribution image of the matrix is finally obtained. According to this, the influence of different user power consumption behaviors caused by different meteorological conditions is obtained, that is, whether the collected data has abnormality can be determined, and the real-time positioning of abnormal data can be realized.

In the present example, real-time processing of a translation window is to restart data processing of the matrix by taking a required time node as the last column of the matrix and taking data of a certain scale.

The characteristic value distribution image includes two types:

The first one is the Ring law, the fixed radius of the outer ring is 1, and the radius of the inner ring is calculated according to the formula of the Ring Law; if the data are randomly distributed, therefore the power grid state is stable, and no large disturbance or fault occurs, then all the characteristic values should be distributed between the inner ring and the outer ring; if large disturbances or faults occur, the characteristic values are concentrated inside the radius of the inner ring.

The second image is the M-P law, if it is in a normal state, distribution of the matrix characteristic values should be basically consistent with an image presented by substituting the data into the formula, and if it is in an abnormal state, there will be great difference (especially the wave peak).

The augmented data source matrix is composed of the basic state matrix and the influence factor matrix (the basic state matrix and the influence factor matrix are spliced up and down, the basic state matrix is on the upper portion, the influence factor matrix is on the lower portion, and a row number ratio of the influence factor matrix to the basic state matrix is about 0.4).

In terms of quantification: it is mainly used to mine the relationship between the data, and there are many types meteorological factors, including temperature, humidity, air pressure, wind speed, rainfall, sunshine, etc. Temperature, humidity and wind speed data are selected as the meteorological factors in the present example; three meteorological indexes: the heat index, the effective temperature and the human body comfort index are calculated based on the data of the three basic meteorological factors; then the Pearson correlation coefficient between the three meteorological indexes and the load data is calculated; and finally, the Pearson correlation coefficient is taken as the further influence factor to form the source matrix with the active load data in a corresponding region, and obtains the random matrix model after the matrix transformation.

The method described in the present example can realize the effective combination of visualization and quantification of correlation analysis, not only studies the influence of a single meteorological factor on the power system, but also considers the function of multiple single meteorological factors and the cumulative effect of the meteorological factors at the same time, and the method can perform load prediction without the guidance of a priori formula, so as to play a decision-making auxiliary support role for reasonable scheduling.

Based on the visualization and the quantification of the correlation analysis, according to the method described in the present example, location parameters and degree parameters of the abnormalities may be extracted from the identification results of the abnormal data. The two parameters are sent to a LB equipped in the regional EI, and the LB may automatically match and execute corresponding coordinated control actions according to a preset response strategy mapping table.

The LB is controller to execute the coordinated control actions, comprise but are not limited to:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation.

### Example 2

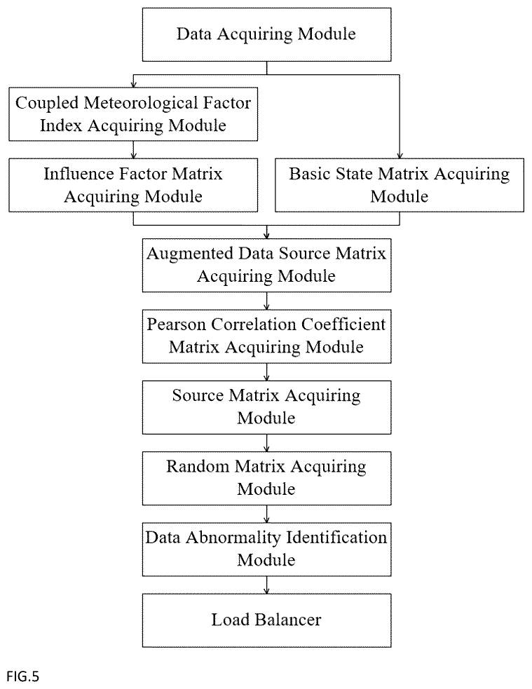

As shown in FIG. 5, the Example 2 of the present application provides a system for eliminating abnormal active loads in a regional EI, comprising:
a data acquiring module, configured to acquire data values of several types of meteorological data in real-time from a regional weather station in a region to be analyzed, and acquire active load data of a regional EI of the region to be analyzed by using an EDCS in the regional EI;
a coupled meteorological factor index acquiring module, configured to calculate a plurality of coupled meteorological factor indexes according to the acquired data values;
an influence factor matrix acquiring module, configured to construct an influence factor matrix based on data of the plurality of the coupled meteorological indexes;
a basic state matrix acquiring module, configured to construct a basic state matrix based on the acquired active load data;
an augmented data source matrix acquiring module, configured to construct an augmented data source matrix by splicing the basic state matrix and the influence factor matrix;
a Pearson correlation coefficient matrix acquiring module, configured to calculate Pearson correlation coefficients by using the augmented data source matrix; and, construct a Pearson correlation coefficient matrix by using the calculated Pearson correlation coefficients;
a source matrix acquiring module, configured to construct a source matrix by splicing the Pearson correlation coefficient matrix and the basic state matrix;
a random matrix acquiring module, configured to perform matrix transformation on the source matrix to obtain a random matrix;
a data abnormality identification module, configured to perform spectrum analysis on characteristic values of the random matrix to obtain a probability density distribution, and identify whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a LB deployed within the regional EI; the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation.

An operating method of the system is the same as the method for analyzing the regional energy Internet load behavior based on the random matrix provided in Example 1 and will not be described in detail herein.

### Example 3

The Example 3 of the present application provides a computer equipment, and the computer equipment comprising: at least one memory for storing computer instructions; and, at least one processor configured to communicate with the at least one memory; wherein the at least one processor, when executing a set of instructions, is configured to perform the method for eliminating abnormal active loads in the regional EI according to Example 1 of the present invention.

### Example 4

The Example 4 of the present application provides a non-transitory computer-readable storage medium, and the non-transitory computer-readable storage medium storing computer instructions, and after a computer reads the computer instructions in the storage medium, the computer executes the method for eliminating abnormal active loads in the regional EI according to Example 1 of the present invention.

A person skilled in the art should understand that the examples of the present application may be provided as a method, a system, or a computer program product. Therefore, the present application may use a form of hardware examples, software examples, or examples with a combination of software and hardware. Moreover, the present application may use a form of a computer program product that is implemented on one or more computer-usable storage media (including but not limited to a magnetic disk storage, an optical storage, and the like) that include computer-usable program code.

The present application is described with reference to flowcharts and/or block diagrams of the method, device (system), and computer program product in the examples of the present application. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of another programmable data processing apparatus to generate a machine, so that the instructions executed by the computer or the processor of another programmable data processing apparatus generate an apparatus for implementing a specific function in one or more processes in the flowcharts and/or in one or more blocks in the block diagrams.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may also be loaded onto a computer or another programmable data processing device, so that a series of operations and steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

A person skilled in the art may understand that all or some of the procedures of the methods of the foregoing examples may be implemented by a computer program instructing relevant hardware. The program may be stored in a computer-readable storage medium. When the program is executed, the procedures of the foregoing method examples may be implemented. The storage medium may be a magnetic disk, an optical disc, a read-only memory (ROM), a Random Access Memory (RAM), or the like.

The above descriptions are merely preferred examples of the present application and are not intended to limit the present application. A person skilled in the art may make various alterations and variations to the present application. Any modification, equivalent replacement, or improvement made and the like within the spirit and principle of the present application shall fall within the protection scope of the present application.

1. A method for eliminating abnormal active loads in a regional energy internet (EI), comprising the following process:
acquiring data values of several types of meteorological data in real-time from a regional weather station in a region to be analyzed, and acquiring active load data of a regional EI of the region to be analyzed by using an electric data collection system (EDCS) in the regional EI;
calculating a plurality of coupled meteorological factor indexes according to the acquired data values;
constructing an influence factor matrix based on data of the plurality of the coupled meteorological indexes;
constructing a basic state matrix based on the acquired active load data;
constructing an augmented data source matrix by splicing the basic state matrix and the influence factor matrix;
calculating Pearson correlation coefficients by using the augmented data source matrix; then, constructing a Pearson correlation coefficient matrix by using the calculated Pearson correlation coefficients;
constructing a source matrix by splicing the Pearson correlation coefficient matrix and the basic state matrix;
performing matrix transformation on the source matrix to obtain a random matrix;
performing spectrum analysis on characteristic values of the random matrix to obtain a probability density distribution;
identifying whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a load balancer (LB) deployed within the regional EI; the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation;
wherein, constructing the augmented data source matrix by splicing the basic state matrix and the influence factor matrix, comprises:
taking time points as number of columns, and taking the active load data represent number of rows, to construct the basic state matrix;
taking the time points as the number of columns, and taking the data of the plurality of the coupled meteorological indexes represent the number of rows, to construct the influence factor matrix; and
top-bottom splicing the basic state matrix and the influence factor matrix, to obtain the augmented data source matrix;
wherein, the basic state matrix is on an upper portion of the augmented data source matrix, and the influence factor matrix is on a lower portion of the augmented data source matrix; and,
calculating the Pearson correlation coefficients by using the augmented data source matrix, comprises:
selecting a sub-matrix from the augmented data source matrix by moving a window, calculating a Pearson correlation coefficient by using the active load data in a certain row of the sub-matrix and the data of the plurality of the coupled meteorological indexes in a row of the sub-matrix corresponding to the certain row; and
obtaining the Pearson correlation coefficients between the active load data and the data of the plurality of the coupled meteorological indexes in the sub-matrix after multiple calculations;
wherein, the Pearson correlation coefficients are configured to reflect linear correlation degrees between the plurality of the coupling meteorological factor indexes and the active load data.

2. The method for eliminating the abnormal active loads in the regional EI according to claim 1,
wherein performing the matrix transformation on the source matrix to obtain the random matrix, comprises the following process:
acquiring the source matrix at a certain sampling moment;
transforming the source matrix into a standard non-Hermitian matrix;
according to the obtained standard non-Hermitian matrix, calculating a plurality of singular value equivalent matrices;
multiplying the plurality of the singular value equivalent matrices to obtain a matrix to be analyzed;
converting the matrix to be analyzed into a standard matrix with a mean value of 1 and a variance of 0; and
calculating a covariance matrix of the standard matrix, and defining the covariance matrix as the random matrix obtained after the matrix transformation.

3. The method for eliminating the abnormal active loads in the regional EI according to claim 1,
wherein performing the spectrum analysis on the characteristic values of the random matrix to obtain the probability density distribution, comprises:
calculating the characteristic values of the random matrix obtained after the matrix transformation;
performing the spectrum analysis according to the characteristic values;
obtaining the probability density distribution of the Pearson correlation coefficients according to results of the spectrum analysis; and
obtaining correspondence linear correlation degrees between the plurality of the coupled meteorological factor indexes and the active load data according to the probability density distribution of the Pearson correlation coefficients.

4. The method for eliminating the abnormal active loads in the regional EI according to claim 1, wherein
a row number ratio of the influence factor matrix to the basic state matrix is 0.4.

5. The method for eliminating the abnormal active loads in the regional EI according to claim 1, wherein
the plurality of the coupled meteorological factor indexes, at least comprises:
a heat index (HI):
$$HI = {c}_{1} + {c}_{2} T + {c}_{3} R + {c}_{4} TR + {c}_{5} {T}^{2} + {c}_{6} {R}^{2} + {c}_{7} {T}^{2} R + {c}_{8} {TR}^{2} + {c}_{9} {T}^{2} {R}^{2} ;$$
wherein, c₁, c₂, c₃, c₄, c₅, c₆, c₇, c₈ and c₉ are constant coefficients, T is temperature and R is relative humidity.

6. The method for eliminating the abnormal active loads in the regional EI according to claim 1, wherein
the plurality of the coupled meteorological factor indexes, at least comprises:
an effective temperature Tₑ:
$${T}_{e} = 37 - \frac{( 37 - {T}_{a} )}{[ 0.68 - 0.14 {R}_{h} + \frac{1}{1.76} + 1.4 {V}^{0.75} ) ]} - 0.29 {T}_{a} ( 1 - {R}_{h} ) ;$$
wherein, Tₐ is an air temperature, Rₕ is the relative humidity, and V is a wind speed.

7. The method for eliminating the abnormal active loads in the regional EI according to claim 1, wherein
the plurality of the coupled meteorological factor indexes, at least comprises:
a human body comfort index k:
$$k = 1.8 {T}_{a} - 0.55 ( 1.8 {T}_{a} - 26 ) ( 1 - {R}_{h} ) - 3.2 \sqrt{V} + 3.2 ;$$
wherein, Tₐ is an air temperature, Rₕ is the relative humidity, and V is a wind speed.

8. A system for eliminating the abnormal active loads in a regional energy internet, comprising:
a data acquiring module, configured to acquire data values of several types of meteorological data in real-time from a regional weather station in a region to be analyzed, and acquire active load data of a regional EI of the region to be analyzed by using an EDCS in the regional EI;
a coupled meteorological factor index acquiring module, configured to calculate a plurality of coupled meteorological factor indexes according to the acquired data values;
an influence factor matrix acquiring module, configured to construct an influence factor matrix based on data of the plurality of the coupled meteorological indexes;
a basic state matrix acquiring module, configured to construct a basic state matrix based on the acquired active load data;
an augmented data source matrix acquiring module, configured to construct an augmented data source matrix by splicing the basic state matrix and the influence factor matrix;
a Pearson correlation coefficient matrix acquiring module, configured to calculate Pearson correlation coefficients by using the augmented data source matrix; and, construct a Pearson correlation coefficient matrix by using the calculated Pearson correlation coefficients;
a source matrix acquiring module, configured to construct a source matrix by splicing the Pearson correlation coefficient matrix and the basic state matrix;
a random matrix acquiring module, configured to perform matrix transformation on the source matrix to obtain a random matrix;
a data abnormality identification module, configured to perform spectrum analysis on characteristic values of the random matrix to obtain a probability density distribution, and identify whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a load balancer (LB) deployed within the regional EI; the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation;
wherein, constructing the augmented data source matrix by splicing the basic state matrix and the influence factor matrix, comprises:
taking time points as number of columns, and taking the active load data represent number of rows, to construct the basic state matrix;
taking the time points as the number of columns, and taking the data of the plurality of the coupled meteorological indexes represent the number of rows, to construct the influence factor matrix; and
top-bottom splicing the basic state matrix and the influence factor matrix, to obtain the augmented data source matrix;
wherein, the basic state matrix is on an upper portion of the augmented data source matrix, and the influence factor matrix is on a lower portion of the augmented data source matrix;
and,
calculating the Pearson correlation coefficients by using the augmented data source matrix, comprises:
selecting a sub-matrix from the augmented data source matrix by moving a window, calculating a Pearson correlation coefficient by using the active load data in a certain row of the sub-matrix and the data of the plurality of the coupled meteorological indexes in a row of the sub-matrix corresponding to the certain row; and
obtaining the Pearson correlation coefficients between the active load data and the data of the plurality of the coupled meteorological indexes in the sub-matrix after multiple calculations;
wherein, the Pearson correlation coefficients are configured to reflect linear correlation degrees between the plurality of the coupling meteorological factor indexes and the active load data.

9. A computer equipment, comprising:
at least one memory for storing computer instructions; and,
at least one processor configured to communicate with the at least one memory;
wherein the at least one processor, when executing a set of instructions, is configured to perform the steps of the method for eliminating abnormal active loads in the regional EI according to claim 1.

10. A non-transitory computer-readable storage medium, having computer instructions stored thereon, and after a computer reads the computer instructions in the storage medium, the computer executes a method for eliminating abnormal active loads in a regional energy internet (EI), the method comprises:
acquiring data values of several types of meteorological data in real-time from a regional weather station in a region to be analyzed, and acquiring active load data of a regional EI of the region to be analyzed by using an electric data collection system (EDCS) in the regional EI;
calculating a plurality of coupled meteorological factor indexes according to the acquired data values;
constructing an influence factor matrix based on data of the plurality of the coupled meteorological indexes;
constructing a basic state matrix based on the acquired active load data;
constructing an augmented data source matrix by splicing the basic state matrix and the influence factor matrix;
calculating Pearson correlation coefficients by using the augmented data source matrix; then, constructing a Pearson correlation coefficient matrix by using the calculated Pearson correlation coefficients;
constructing a source matrix by splicing the Pearson correlation coefficient matrix and the basic state matrix;
performing matrix transformation on the source matrix to obtain a random matrix;
performing spectrum analysis on characteristic values of the random matrix to obtain a probability density distribution;
identifying whether there are abnormalities in the active load data by comparing the obtained probability density distribution with a historical probability density distribution in a normal state; and
when the abnormalities in the active load data are identified, send location parameters of the abnormalities and degree parameters of the abnormalities in a result of the identification to a load balancer (LB) deployed within the regional EI; the LB is controlled to execute corresponding coordinated control actions according to a preset response strategy mapping table, specially comprises:
when an abnormal high load is identified, the LB is controlled to lower a power supply priority of an unnecessary load at an abnormal location according to the location parameters of the abnormalities; or
when an abnormal low load is identified, the LB is controlled to increase controllable load switching of a degree parameter value according to the degree parameters of the abnormalities, to stabilize the load fluctuation;
wherein, constructing the augmented data source matrix by splicing the basic state matrix and the influence factor matrix, comprises:
taking time points as number of columns, and taking the active load data represent number of rows, to construct the basic state matrix;
taking the time points as the number of columns, and taking the data of the plurality of the coupled meteorological indexes represent the number of rows, to construct the influence factor matrix; and
top-bottom splicing the basic state matrix and the influence factor matrix, to obtain the augmented data source matrix;
wherein, the basic state matrix is on an upper portion of the augmented data source matrix, and the influence factor matrix is on a lower portion of the augmented data source matrix;
and,
calculating the Pearson correlation coefficients by using the augmented data source matrix, comprises:
selecting a sub-matrix from the augmented data source matrix by moving a window, calculating a Pearson correlation coefficient by using the active load data in a certain row of the sub-matrix and the data of the plurality of the coupled meteorological indexes in a row of the sub-matrix corresponding to the certain row; and
obtaining the Pearson correlation coefficients between the active load data and the data of the plurality of the coupled meteorological indexes in the sub-matrix after multiple calculations;
wherein, the Pearson correlation coefficients are configured to reflect linear correlation degrees between the plurality of the coupling meteorological factor indexes and the active load data.
